(19) United States
(12) Patent Application Publication
(10) Pub. No.: US 2024/0269777 A1
(43) Pub. Date: Aug. 15, 2024

(54) Electrode Etching Apparatus

(71) Applicant: LG Energy Solution, Ltd., Seoul (KR)

(72) Inventors: Dong Hyeuk Park, Daejeon (KR); Sungjun Jo, Daejeon (KR)

(73) Assignee: LG Energy Solution, Ltd., Seoul (KR)

(21) Appl. No.: 18/570,191

(22) PCT Filed: Nov. 2, 2022
(86) PCT No.: PCT/KR2022/017065

§ 371 Date: Dec. 14, 2023

(30) Foreign Application Priority Data
Nov. 3, 2021 (KR) 10-2021-0149907

(51) Int. Cl. B23K 26/362; H01M 4/04

(52) U.S. Cl. CPC B23K 26/362; H01M 4/04

(57) ABSTRACT

The present invention includes an electrode assembly support roller, and a laser irradiation device.

The electrode assembly support roller includes two or more cylindrical roller segments, the two or more cylindrical roller segments are coupled to one shaft for fixation in a spaced-apart manner with a adjacent roller segment, and the laser irradiation device is located to be able to irradiate a separated space formed between the cylindrical roller segments with a laser beam.

### CROSS-REFERENCE TO RELATED APPLICATIONS

This application is a national stage entry under 35 U.S.C. § 371 of International Application No. PCT/KR2022/017065, filed on Nov. 2, 2022, which claims priority to Korean Patent Application No. 10-2021-0149907, filed on Nov. 3, 2021, the disclosures of which are incorporated herein in their entireties.

### TECHNICAL FIELD

The present invention relates to an electrode etching apparatus used for etching an electrode active material or the like.

### BACKGROUND ART

As the demand for mobile devices, electric vehicles, and the like increases, the demand for secondary batteries is rapidly increasing. In particular, among secondary batteries, lithium secondary batteries, which have high energy density and high voltage, have been commercialized and widely used.

The lithium secondary battery has a structure in which an electrode in which an active material is coated on a current collector, that is, an electrode assembly with porous separator interposed between a positive electrode and a negative electrode, is impregnated with an electrolyte containing a lithium salt. The electrode is manufactured, by forming an active material layer on a current collector via a mixing process of mixing/dispersing an active material, a binder, and a conductive material in a solvent to prepare a slurry, a coating process of coating the active material slurry on the current collector having a thin-film form and drying it, and a pressing process for increasing a capacity density of the electrode subjected to the coating process and enhancing the adhesiveness between the current collector and the active material.

When the active material slurry is applied to the current collector, as shown in FIG. 1, because a sliding portion in which the thickness of the active material layer gradually decreases is formed at an edge of the active material layer, a problem of reducing the capacity of the active material layer arises. In addition, when the slurry is applied to both sides of the current collector, mismatching occurs in which the positions of the slurry applied to the upper side and the lower side do not match. Such mismatching causes deviation of the position of the active material layer when the anode and the negative electrode face each other, and such a deviated portion degrades the charge/discharge efficiency. In particular, the mismatching portion may deposit lithium on the surface of the negative electrode, and if such lithium deposition occurs for a long time, the battery capacity decreases.

Therefore, a process of etching the sliding portion is performed to uniformly form the end portion of the active material layer and prevent the formation of the sliding portion and/or the mismatching portion. Etching of the conventional sliding portion is performed by a method as shown in FIG. 2. That is, while allowing travel of an electrode assembly having an electrode active material layer formed on the upper side or the lower side of a current collector sheet, or both the upper side and the lower side by a roll-to-roll process, by irradiating a laser beam by a laser irradiation device installed on the upper or lower part of the electrode assembly or both the upper and lower parts, the sliding portion of the electrode active material layer is etched and removed.

However, according to such a method, there is a problem that a vertical swell occurs in the electrode assembly 50 located between the rolls, which causes the etching position to fluctuate, and poor laser focusing, resulting in frequent poor etching.

### PRIOR ART DOCUMENT

### Patent Document

Japanese Laid-open Patent Publication No. 2000-251942

### DISCLOSURE

### Technical Problem

The present invention was devised to solve the above problems of the related art.

An object of the present invention is to provide an electrode etching apparatus which improves the accuracy of etching (ablation), and can effectively prevent damage to the etching die due to laser beams and an occurrence of damage to the electrode assembly, by stably fixing the electrode assembly to be etched.

### Technical Solution

In order to achieve the above object, the present invention provides an electrode etching apparatus including:
an electrode assembly support roller; and
a laser irradiation device,
wherein the electrode assembly support roller includes two or more cylindrical roller segments, and the two or more cylindrical roller segments are coupled to one shaft for fixation in a spaced-apart manner with a adjacent roller segment, and
the laser irradiation device is located to be able to irradiate a separated space formed between the cylindrical roller segments with a laser beam.

In an embodiment of the invention, one or more of the cylindrical roller segments are able to be moved and fixed along a shaft for fixation.

In an embodiment of the present invention, one or more cylindrical roller segments that are able to be moved and fixed may be one cylindrical roller segment located on an outermost side of one end of the support roller, two cylindrical roller segments located on the outermost side of both ends of the support roller, or the entire cylindrical roller segments that make up the support roller.

In an embodiment of the invention, one or more cylindrical roller segments that are able to be moved and fixed may be moved and fixed in accordance with the width of the electrode assembly.

In an embodiment of the invention, the shaft for fixation may be a rotary shaft.

In an embodiment of the present invention, one or more cylindrical roller segments among the cylindrical roller segments may be provided with one or more suction holes on a circumferential surface thereof.

In an embodiment of the present invention, the cylindrical roller segment having one or more suction holes may be one cylindrical roller segment located at the outermost side of one end of the support roller, the two outermost cylindrical roller segments located at the outermost side of both ends of the support roller, or the entire cylindrical roller segments that make up the support roller.

In an embodiment of the invention, the suction hole may be connected to a suction device through an internal space of the cylindrical roller segment.

In an embodiment of the present invention, the electrode etching apparatus may further include a traveling equipment that causes the electrode assembly to travel, while forming an internal angle of 70 to 160 degrees around the support roller.

In an embodiment of the invention, the traveling equipment may include traveling rollers located in front and behind the support rollers on the basis of a movement direction of the electrode assembly.

In an embodiment of the present invention, the laser irradiation device may be located above the outer side of the electrode assembly whose inner side is supported by the circumferential surface of the support roller by a surface contact.

In an embodiment of the invention, the laser irradiation device may be installed to be movable along an axis parallel to the shaft for fixation of the cylindrical roller segment.

In an embodiment of the invention, the laser irradiation device may be fixed to a guide rail located on an axis parallel to the shaft for fixation of the cylindrical roller segment.

In an embodiment of the present invention, the electrode assembly may have an inner side formed of a current collector sheet, and an outer side formed of an electrode active material layer.

In an embodiment of the present invention, the electrode etching apparatus may be used for etching the electrode active material layer in an electrode assembly including the electrode active material layer laminated on the current collector sheet.

### Advantageous Effects

The electrode etching apparatus of the present invention provides an effect which improves the accuracy of etching (ablation), and can effectively prevent damage to the etching die due to laser beams and an occurrence of damage to the electrode assembly, by stably fixing the electrode assembly to be etched. Also, excellent etching quality is provided by such an effect.

### DESCRIPTION OF DRAWINGS

FIG. 1 is a cross-sectional view showing an embodiment of an electrode assembly.

FIG. 2 is a cross-sectional view schematically showing an embodiment of a conventional electrode assembly etching process.

FIG. 3 is a cross-sectional view schematically showing another embodiment of the electrode assembly etching process.

FIG. 4 is a cross-sectional view schematically showing an embodiment of the electrode etching apparatus of the present invention.

FIG. 5 is a perspective view schematically showing an embodiment of the electrode etching apparatus of the present invention.

FIG. 6 is a perspective view schematically showing an embodiment of the electrode etching apparatus of the present invention.

FIG. 7 is a cross-sectional view schematically showing a usage state of the electrode etching apparatus of the present invention.

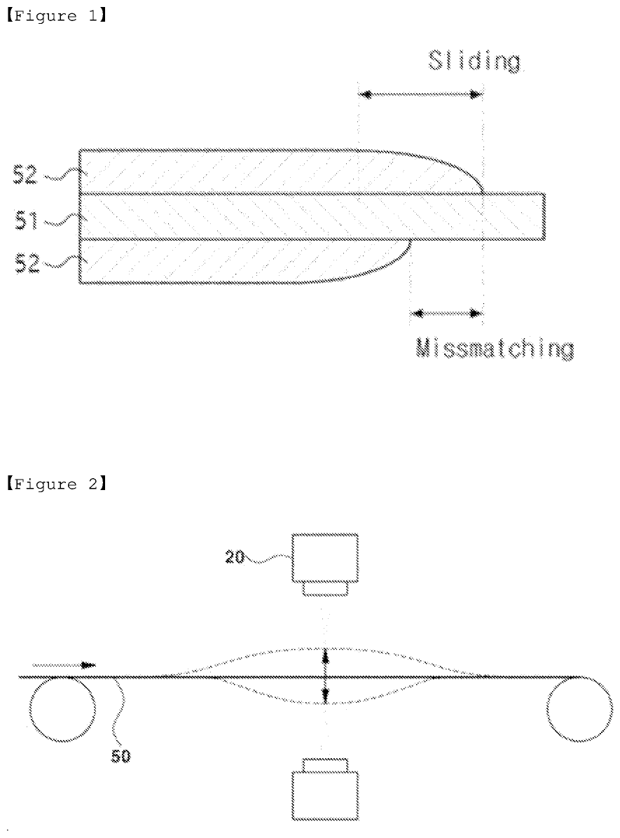

### BEST MODE

Hereinafter, embodiments of the present invention will be described in detail with reference to the accompanying drawings so that those skilled in the art can easily implement the present invention. This invention may, however, be embodied in many different forms and is not limited to the embodiments set forth herein. Similar parts are denoted by the same reference numerals throughout the specification.

When a certain constituent element is referred to as being “connected, equipped or installed” to another component, although it may be directly connected or installed to another component, it should be understood that there may be another constituent elements may be present between them. On the other hand, when a certain constituent element is referred to as being “directly connected to, equipped with, or installed in” another constituent element, it should be understood that there are no other constituent elements in between. On the other hand, other expressions describing relationships between constituent elements, namely “on top” and “directly on top” or “between” and “directly between” or “adjacent to” and “directly next to” should be interpreted in the same way.

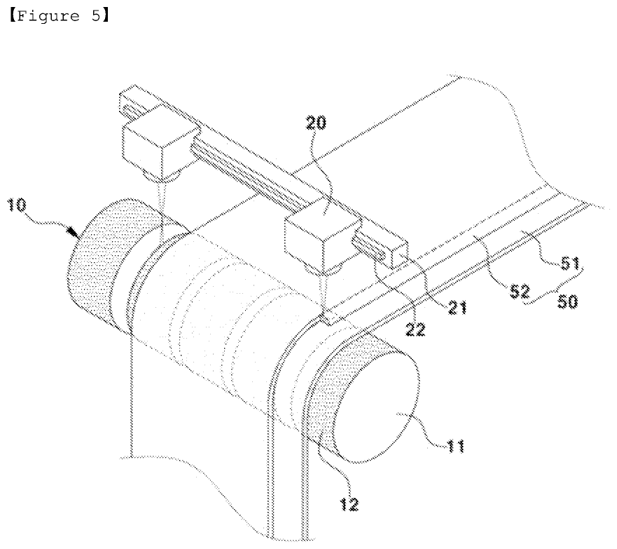

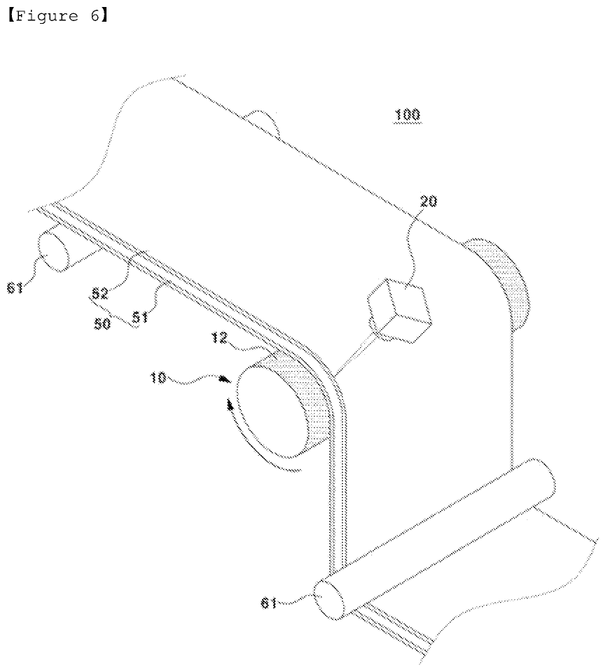

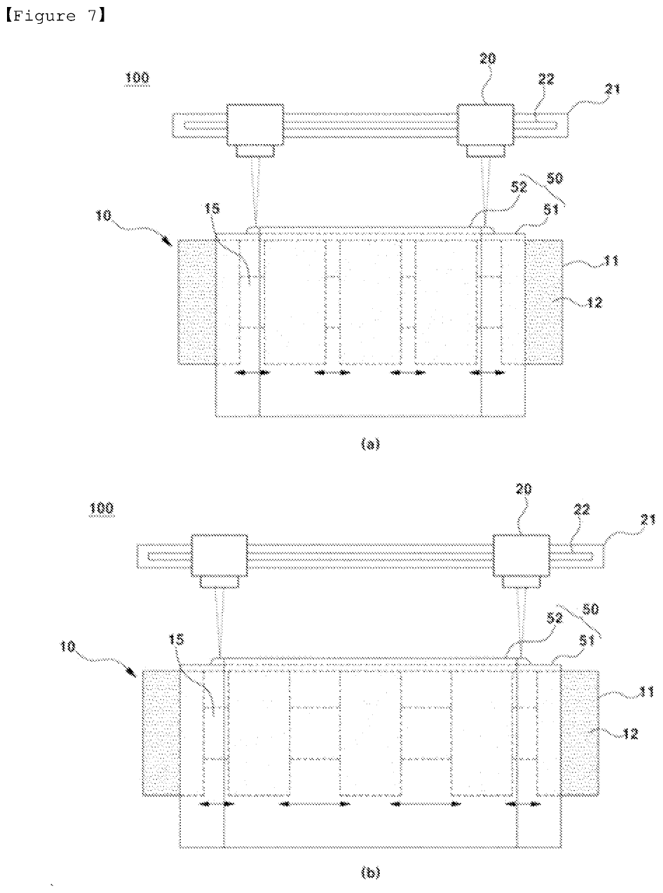

FIGS. 4 and 5 are a cross-sectional view and a perspective view schematically showing an embodiment of the electrode etching apparatus of the present invention, FIG. 6 is a perspective view schematically showing an embodiment of the electrode etching apparatus of the present invention, and FIG. 7 is a cross-sectional view schematically showing a usage state of the electrode etching apparatus of the present invention.

An electrode etching (ablation) apparatus 100 of the present invention includes an electrode assembly support roller 10, and a laser irradiation device 20, as shown in FIGS. 4 to 7.

The electrode assembly support roller 10 includes two or more cylindrical roller segments 11, and the two or more cylindrical roller segments 11 are coupled to the roller segment 11 adjacent to one shaft for fixation 15 in a spaced-apart manner.

The laser irradiation device 20 is disposed to be able to irradiate a separated space formed between the cylindrical roller segments 11 with a laser beam.

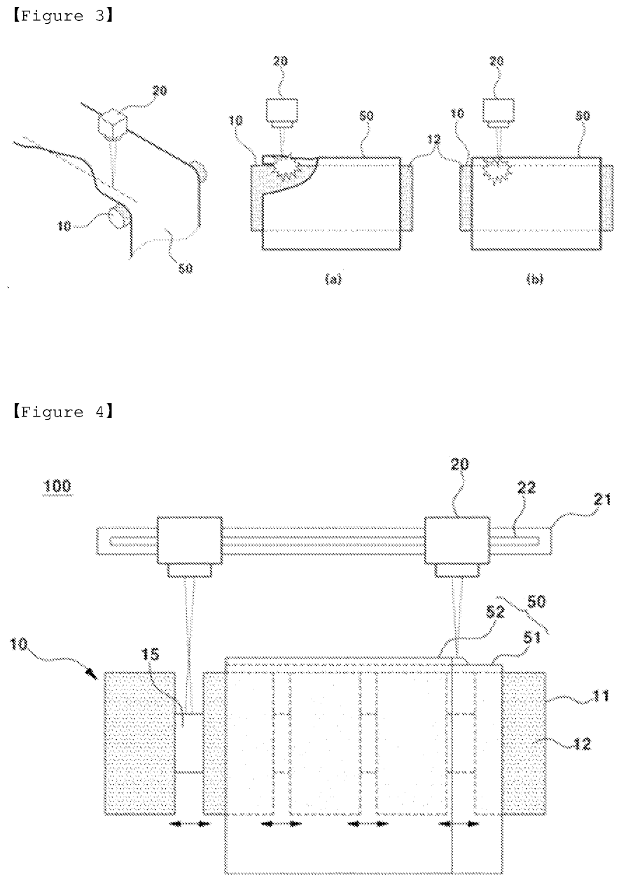

Because the electrode etching apparatus 100 of the present invention is configured such that the electrode assembly support roller 10 includes two or more cylindrical roller segments 11, as shown in FIG. 3(a), there is a feature that can prevent damage to the electrode assembly support roller 10 and the resulting damage to the electrode assembly, which may occur when the electrode assembly 50 is damaged. In addition, as shown in FIG. 3(b), when the output adjustment of the laser irradiation device 20 fails, there is a feature that can prevent damage to the electrode assembly support roller 10 and the resulting damage to the electrode assembly, which may occur due to the laser beam passing through the electrode assembly 50.

In an embodiment of the invention, one or more of the cylindrical roller segments 11 have a structure that can be moved and fixed along the shaft for fixation 15. As described above, when one or more of the cylindrical roller segments 11 are configured to be movable and fixed, it is possible to provide an advantage capable of utilizing the electrode etching apparatus 100 to correspond to the electrode assemblies 50 having various sizes.

The cylindrical roller segment 11 that can be moved and fixed may be one cylindrical roller segment 11 located on the outermost side of one end of the support roller 10, or may be two cylindrical roller segments 11 located on the outermost side of both ends of the support roller 11, or may be the entire cylindrical roller segments 11 that make up the support roller 10.

In an embodiment of the present invention, one or more cylindrical roller segments 11 that can be moved and fixed are movable and can be fixed in accordance with the width of the electrode assembly 50. That is, since the separated space between the cylindrical roller segments 11 to be irradiated with the laser beam also changes according to the width of the electrode assembly 50, this configuration enables adjustment of the position of the cylindrical roller segments 11 in accordance with this change.

In an embodiment of the invention, the shaft for fixation 15 can be configured as a rotary shaft. When the shaft for fixation 15 is configured as a rotary shaft as described above, there is provided an advantage in which the cylindrical roller segment 11 that constitutes the support roller 10 can be rotated, and the electrode assembly 50 to be fed can travel, while being more smoothly supported.

In an embodiment of the present invention, the rotary shaft can be configured to rotate passively while coming into contact with the electrode assembly 50 to be fed or rotated by a driving device provided separately.

In an embodiment of the present invention, one or more cylindrical roller segments 11 among the cylindrical roller segments 11 may have one or more suction holes 12 on a circumferential surface.

The cylindrical roller segment 11 having one or more suction holes may be one cylindrical roller segment 11 located at the outermost side of one end of the support roller 10, may be the two outermost cylindrical roller segments 11 located at the outermost side of both ends of the support roller 10, or may be the entire cylindrical roller segments 11 that make up the support roller 10.

In the present invention, the electrode assembly 50 may be made up of, for example, a current collector sheet 51, and electrode active material layers 52 laminated on the upper side or lower side of the current collector sheet, or both the upper and lower sides. The electrode etching apparatus 100 of the present invention can perform a function of irradiating a laser beam to etch and remove the electrode active material layer 52.

For example, the electrode etching apparatus 100 of the present invention can preferably be used to etch (ablate) and remove the sliding portion formed at the end portion when coating the electrode active material, and can also be used to remove the electrode active material from the current collector sheet 51 to form a non-coating portion.

Therefore, the suction holes 12 can perform a function of sucking and removing the electrode active material particles generated when the electrode active material is removed. In addition, the suction holes 12 can also perform a function of absorbing and fixing the lower side of the electrode assembly 50.

In an embodiment of the invention, the suction holes 12 can be connected with a suction device through the internal space of the cylindrical roller segment. At this time, the suction hole 12 and the suction device may be connected by an exhaust pipe. Further, the exhaust pipe may pass through the internal space of the shaft for fixation 15 and be connected to the suction device, and the internal space of the shaft for fixation 15 itself can also serve as the exhaust pipe.

The suction hole 12 may be formed entirely on the circumferential surface of the cylindrical roller segment 11. However, it is not formed only in this manner, but can be formed in various forms in consideration of the type of the object to be etched, the suction efficiency and the like.

In an embodiment of the present invention, the electrode etching apparatus 100 may further include a traveling equipment that allows the electrode assembly to travel while forming an internal angle of 70 degrees to 160 degrees, preferably 80 degrees to 130 degrees, and more preferably 85 degrees to 95 degrees around the support roller 10, as shown in FIG. 6.

When the electrode assembly 50 travels while forming the internal angle as described above, since a curved portion formed in the electrode assembly 50 forms a large contact area with the support roller 10, the curved portion can be more stably supported by the support roller 10 and thus is preferable.

In an embodiment of the present invention, the traveling equipment may be configured to include traveling rollers 61 located forward and rearward of the support rollers 10 on the basis of the movement direction of the electrode assembly.

The traveling roller 61 may be passively rotated while coming into contact with the electrode assembly 50 to be fed, or may be rotated by a driving device provided separately.

In an embodiment of the present invention, the laser irradiation device 20 may be located above the outer side of the electrode assembly 50 whose inner side is supported by the circumferential surface of the support roller 50 by a surface contact. That is, the laser irradiation device 20 can irradiate the electrode assembly 50 with a laser beam at the same position as described above to perform etching.

In an embodiment of the present invention, the laser irradiation device 20 can be installed to be movable along an axis parallel to the shaft for fixation 15 of the cylindrical roller segment. That is, in the present invention, although it is possible to form a separated space irradiated with a laser beam by movement of the cylindrical roller segment 11, when the laser irradiation device 20 can be moved as described above, it is preferable because the electrode etching apparatus 100 in accordance with the size of the electrode assembly 50 can be more easily set.

In an embodiment of the present invention, the laser irradiation device 20 may be fixed to a guide rail 21 located on an axis parallel to the shaft for fixation of the cylindrical roller segment 11, as shown in FIGS. 4 and 7. For example, a protrusion is formed in one of the guide rail 21 and the laser irradiation device 20, and a guide groove 22 is provided on the other thereof so that the laser irradiation device 20 can move by sliding. Thus, they can be coupled together to form the sliding portion.

In the present invention, as the laser irradiation device 20, a known laser irradiation device that can be used for etching (ablation) of the material can be used without limitation.

In an embodiment of the present invention, the electrode assembly 50 may have an inner side formed of the current collector sheet 51, and an outer side formed of the electrode active material layer 52.

In an embodiment of the present invention, the electrode etching apparatus 100 can be used for etching the electrode active material layer 52 in an electrode assembly including the electrode active material layer 52 laminated on the current collector sheet 51.

In the electrode etching apparatus 100 of the present invention, except for the configurations specified above, various components known in the field can be adopted without limitation, and structures of each component included in the electrode etching apparatus 100 can also be manufacture with structures known in this field when including relevant technical features.

Although the present invention has been described in relation to the preferred embodiment as described above, various modifications and variations may be made without departing from the spirit and scope of the invention. Accordingly, the appended claims shall include such modifications or variations insofar as they fall within the spirit of the present invention.

### DESCRIPTION OF SYMBOLS

| | |
|---|---|
| 10: Electrode assembly support roller | |
| 11: Cylindrical roller segment | |
| 12: Suction hole | 15: Shaft for fixation |
| 20: Laser irradiation device | 21: Guide rail |
| 22: Guide groove | 50: Electrode assembly |
| 51: Current collector sheet | |
| 52: Electrode active material layer | |
| 61: Traveling roller | 100: Electrode etching apparatus |

1. An electrode etching apparatus, comprising:
an electrode assembly support roller; and
a laser irradiation device,
wherein the electrode assembly support roller includes two or more cylindrical roller segments, and the two or more cylindrical roller segments are coupled to a common shaft, each cylindrical roller segment being configured to be fixed to the common shaft spaced apart from adjacent ones of the cylindrical roller segments, and the laser irradiation device is configured to irradiate a separated space extending between the adjacent ones of the cylindrical roller segments with a laser beam.

2. The electrode etching apparatus according to claim 1, wherein one or more of the cylindrical roller segments are configured to be moved along the common shaft and fixed to the common shaft.

3. The electrode etching apparatus according to claim 2, wherein the one or more cylindrical roller segments that are configured to be moved along the common shaft and fixed to the common shaft are one cylindrical roller segment located on an outermost side of one end of the support roller, two cylindrical roller segments located on outermost side of opposite ends of the support roller, or all of the cylindrical roller segments.

4. The electrode etching apparatus according to claim 2, wherein the one or more cylindrical roller segments that are configured to be moved along the common shaft and fixed to the common shaft are configured to be moved in a width direction of an electrode assembly extending across the electrode assembly support roller.

5. The electrode etching apparatus according to claim 1, wherein the common shaft is a rotary shaft.

6. The electrode etching apparatus according to claim 1, wherein one or more of the cylindrical roller segments each have one or more suction holes extending into a circumferential surface thereof.

7. The electrode etching apparatus according to claim 6, wherein the one or more of the cylindrical roller segments each having the one or more suction holes is one cylindrical roller segment located at an outermost side of one end of the support roller, two cylindrical roller segments located at outermost sides of opposite ends of the support roller, or all of the cylindrical roller segments.

8. The electrode etching apparatus according to claim 6, wherein each suction hole is connected to a suction device through an internal space within the one or more of the cylindrical roller segments.

9. The electrode etching apparatus according to claim 1, further comprising traveling equipment that is configured to move an electrode assembly across the support roller, while forming an internal angle of 70 to 160 degrees around the support roller.

10. The electrode etching apparatus according to claim 9, wherein the traveling equipment comprises traveling rollers located in front of and behind the support roller relative to a movement direction of the electrode assembly.

11. The electrode etching apparatus according to claim 1, wherein the laser irradiation device is configured to be located above an outer side of an electrode assembly whose inner side is supported by a circumferential surface of the support roller by a surface contact.

12. The electrode etching apparatus according to claim 11, wherein the laser irradiation device is configured to be movable along an axis parallel to a longitudinal axis of the common shaft.

13. The electrode etching apparatus according to claim 12, wherein the laser irradiation device is slidably coupled to a guide rail extending along an axis parallel to the common shaft.

14. The electrode etching apparatus according to claim 11, wherein the electrode assembly has an inner side formed of a current collector sheet, and an outer side formed of an electrode active material layer.

15. The electrode etching apparatus according to claim 1, wherein the electrode etching apparatus is configured to etch an electrode active material layer laminated on a current collector sheet of an electrode assembly.
